(19) United States
(12) Patent Application Publication
(10) Pub. No.: US 2018/0060094 A1
(43) Pub. Date: Mar. 1, 2018

(54) HELP SYSTEM AND HELP PRESENTATION METHOD

(71) Applicant: KYOCERA DOCUMENT SOLUTIONS INC., Osaka (JP)

(72) Inventor: CHIKA TSUJI, OSAKA (JP)

(21) Appl. No.: 15/686,118

(22) Filed: Aug. 24, 2017

(30) Foreign Application Priority Data
Aug. 26, 2016 (JP) 2016-165319

(51) Int. Cl. G06F 9/44; H04N 1/00

(52) U.S. Cl. CPC G06F 9/4446; H04N 1/00416

(57) ABSTRACT

A help system include: an apparatus management server; one or more image forming apparatuses; a help server; and a mobile terminal, in which the mobile terminal acquires a serial number of the image forming apparatus of which the user wants to know help information among the one or more image forming apparatuses, and sends the serial number to the apparatus management server, the apparatus management server searches an apparatus information database based on the received serial number, extracts the corresponding apparatus information, and sends the extracted apparatus information to the help server, the help server receives the apparatus information sent from the apparatus management server, extracts help information relating to the sent apparatus information among the help information stored in a manual database, and sends the extracted apparatus information to the mobile terminal, and the mobile terminal presents the received help information to the user.

### CROSS REFERENCE TO RELATED APPLICATION

This application claims the benefit of Japanese Priority Patent Application JP 2016-165319 filed Aug. 26, 2016, the entire contents of which are incorporated herein by reference.

### BACKGROUND OF THE INVENTION

### 1. Field of the Invention

The present disclosure relates to a help system and a help presentation method that present help information when using an image forming apparatus (MFP, Multifunction Peripheral).

### 2. Description of Related Art

Recent image forming apparatuses are equipped with not only basic functions such as a printing function and a copy function but also various functions. The image forming apparatuses are equipped with very many functions, and some functions themselves are complicated. Therefore, it is hard to say that users who use the image forming apparatus fully utilize the functions.

What is necessary for a user to use a complicated function is help that describes the outline of the function, operational procedure, and the like. The “help” in one word have various formats, and the most basic one is in the format of a document such as a product manual or a user guide. These documents are listed mainly for each model on the homepage of each manufacturer, and it is possible to refer to the documents by downloading them. Although the content of these documents is enormous as the functions of the image forming apparatus are increased, the user needs to search for necessary parts himself/herself.

Meanwhile, depending on the model, some image forming apparatuses themselves are provided with help buttons. In that case, since pressing the help button displays the operational procedure on a display panel, it is possible to check the operational procedure on the display panel. However, in this case, since the operational procedure is displayed on the target apparatus itself, the function cannot be actually used via the display panel while referring to the description.

It is desirable to minimize the user's trouble of referring to help in cooperation with an apparatus management system.

### SUMMARY OF THE INVENTION

A help system according to an embodiment of the present disclosure includes an apparatus management server; one or more image forming apparatuses; a help server; and a mobile terminal, in which the apparatus management server includes a first communication device capable of performing network communication, a first memory that stores an apparatus information database, apparatus information relating to the one or more image forming apparatuses being stored in the apparatus information database, a second memory that stores a first information processing program, and a first processor that executes the first information processing program, when the first processor executes the first information processing program, the first processor collects the apparatus information from the one or more image forming apparatuses and manages the collected apparatus information in the apparatus information database, and sends the apparatus information to the help server, the one or more image forming apparatuses each include a second communication device capable of performing network communication, a third memory that stores a second information processing program, and a second processor that executes the second information processing program, when the second processor executes the second information processing program, the second processor sends the apparatus information relating to the image forming apparatus itself to the apparatus management server, the help server includes a third communication device capable of performing network communication, a fourth memory that stores a manual database, help information to be presented to a user being categorized and stored in the manual database, a fifth memory that stores a third information processing program, and a third processor that executes the third information processing program, when the third processor executes the third information processing program, the third processor extracts help information relating to the sent apparatus information among the help information stored in the manual database and sends the extracted help information to the mobile terminal, and receives the apparatus information sent from the apparatus management server, the mobile terminal includes a fourth communication device capable of performing network communication, a sixth memory that stores a forth information processing program, and a forth processor that executes the forth information processing program, and when the forth processor executes the forth information processing program, the forth processor operates as a user interface for sending/receiving information to/from the apparatus management server, and operates as a user interface for sending/receiving information to/from the help server, and in which the forth processor of the mobile terminal acquires a serial number of the image forming apparatus of which the user wants to know help information among the one or more image forming apparatuses, the forth processor of the mobile terminal sends the serial number to the apparatus management server, the first processor of the apparatus management server searches the apparatus information database based on the received serial number and extracts the corresponding apparatus information, the first processor of the apparatus management server sends the extracted apparatus information to the help server, the third processor of the help server receives the apparatus information sent from the apparatus management server, the third processor of the help server extracts help information relating to the sent apparatus information among the help information stored in the manual database and sends the extracted apparatus information to the mobile terminal, and the forth processor of the mobile terminal presents the received help information to the user.

With this configuration, it is possible to minimize the user's trouble of referring to help in cooperation with an apparatus management system.

A help presentation method according to an embodiment of the present disclosure is a help presentation method for a help system including an apparatus management server, one or more image forming apparatuses, a help server, and a mobile terminal connected to each other, the help presentation method including: acquiring, by the mobile terminal, a serial number of the image forming apparatus of which a user wants to know help information among the one or more image forming apparatuses, sending, by the mobile terminal, the serial number to the apparatus management server, searching, by the apparatus management server, an apparatus information database based on the received serial number and extracts the corresponding apparatus information, apparatus information relating to the one or more image forming apparatuses being stored in the apparatus information database, sending, by the apparatus management server, the extracted apparatus information to the help server, receiving, by the help server, the apparatus information sent from the apparatus management server, extracting, by the help server, help information relating to the sent apparatus information among the help information stored in a manual database and sending the extracted apparatus information to the mobile terminal, the help information to be presented to the user being categorized and stored in the manual database, and presenting, by the mobile terminal, the received help information to the user.

These and other objects, features and advantages of the present disclosure will become more apparent in light of the following detailed description of best mode embodiments thereof, as illustrated in the accompanying drawings.

### BRIEF DESCRIPTION OF THE DRAWINGS

FIG. 1 schematically illustrates flow of processing (part 1) in a help system 1 according to an embodiment of the present disclosure and a configuration of the help system 1;

FIG. 2 shows a configuration of an apparatus management server 10 that is a general-purpose computer;

FIG. 3 schematically shows a configuration of an image forming apparatus 20;

FIG. 4 shows a configuration of a help server 30 that is a general-purpose computer;

FIG. 5 shows a configuration of a mobile terminal 40 that is a general-purpose computer;

FIG. 6 illustrates a display example (part 1) of help information displayed by the mobile terminal 40;

FIG. 7 illustrates a display example (part 2) of help information displayed by the mobile terminal 40;

FIG. 8 illustrates a display example (part 3) of help information displayed by the mobile terminal 40;

FIG. 9 illustrates a sequence of detailed flow of processing (part 1) in the help system 1 according to the embodiment of the present disclosure;

FIG. 10 schematically illustrates flow (part 2) of processing in the help system 1 according to the embodiment of the present disclosure;

FIG. 11 illustrates a display example (part 4) of help information displayed by the mobile terminal 40;

FIG. 12 illustrates a display example (part 5) of help information displayed by the mobile terminal 40;

FIG. 13 illustrates the detailed flow of processing (part 2) in the help system 1 according to the embodiment of the present disclosure; and

FIG. 14 schematically illustrates flow of processing (part 3) in the help system 1 according to the embodiment of the present disclosure.

### DETAILED DESCRIPTION OF THE PREFERRED EMBODIMENTS

Hereinafter, an embodiment of the present disclosure will be described with reference to the drawings.

[Overview]

First, an overview of a help system according to an embodiment of the present disclosure will be described.

The help system according to the embodiment of the present disclosure is in cooperation with an apparatus management system in order to present help suitable for an image forming apparatus used by a user.

The apparatus management system collectively manages image forming apparatuses connected to a network, and can also check basic information or functions of the image forming apparatus, information on the generated alert in progress, and the like.

Therefore, by designating the image forming apparatus that is to present help on the apparatus management system and linking the help system with information, it is possible for the user to narrow down necessary help information.

The method can be realized also for a printer without a display panel and an image forming apparatus without a help button. Further, since the apparatus management system manages also information on users, it is also possible to switch the help information that can be referred to (for example, separate content for general users and content for service persons from each other) depending on the role of the user.

The overview of the help system according to the embodiment of the present disclosure has been described heretofore.

[Schematic Configuration and Flow of Processing (Part 1)]

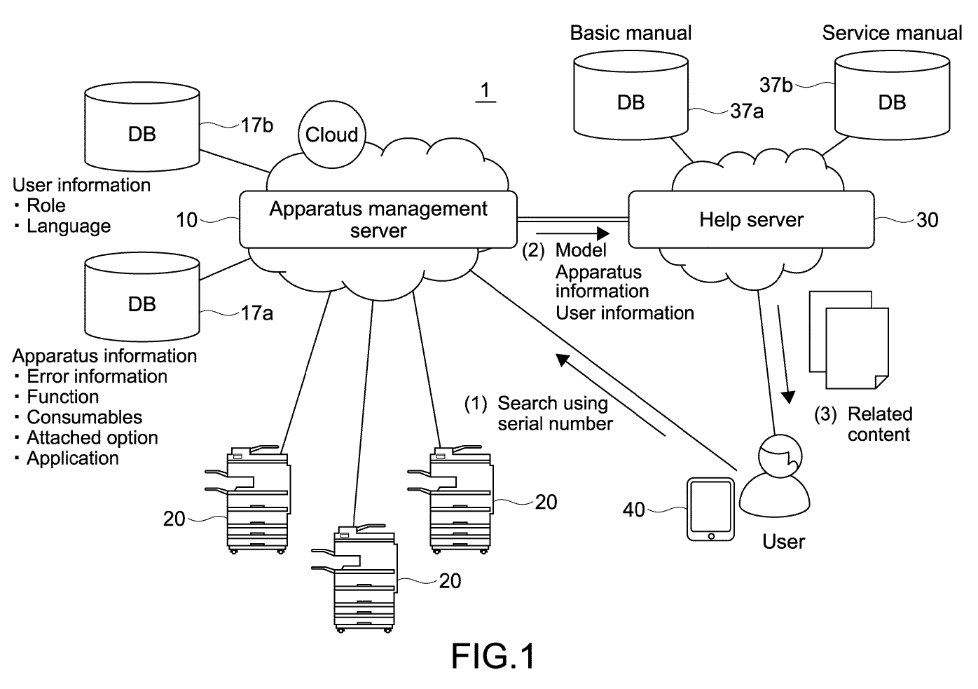

Next, an overview of flow of processing (part 1) in the help system according to the embodiment of the present disclosure and a configuration of the help system will be described. FIG. 1 schematically illustrates flow of processing (part 1) in a help system 1 according to the embodiment of the present disclosure and a configuration of the help system 1.

The help system 1 includes a help server 30, a device management server 10, one or more image forming apparatuses 20, and a user's mobile terminal 40.

As shown in FIG. 1, there are one or more image forming apparatuses 20 in a customer site, and the one or more image forming apparatuses 20 are connected to the apparatus management server 10 via a network. The apparatus management server 10 manages the one or more image forming apparatuses 20. The apparatus management server 10 may be on the cloud.

The apparatus management server 10 includes an apparatus information DB 17a and a user information DB 17b.

The apparatus information DB 17a stores information on a history of error information generated in the image forming apparatus 20 to be managed, a manufacturer name, a model name, a serial number, a type of an attached option, a type of a function, a type of an installed application program, and status information of the image forming apparatus 20, and the like.

The user information DB 17b stores the role of the user such as distinction as to whether the user is a general user or a service person. In addition, the user information DB 17b stores information on the language used by the user. The role and language are used to customize, according to the user, help information to be presented to the user.

The help server 30 is connected to the apparatus management server 10. The help server 30 may be on the cloud.

The help server 30 includes a basic manual DB 37a (manual database) and a service manual DB 37b (manual database).

The service manual DB 37b categorizes and stores information used for maintenance by a service person for each model and function.

The basic manual DB 37a categorizes and stores information other than the information used for maintenance by the service person for each model and function.

Every time a new model is developed or a function is added, the basic manual DB 37a and the service manual DB 37b add information as needed.

The overview of the processing is as follows.

(1) First, the mobile terminal 40 of the user logs in to the apparatus management server 10. The mobile terminal 40 is a smartphone, a tablet-type PC (Personal Computer), or the like. The mobile terminal 40 inputs the serial number of the image forming apparatus 20 of which the user wants to know help information to the apparatus management server 10.

(2) Next, the apparatus management server 10 acquires the model name and the apparatus information (configuration information) of the target image forming apparatus 20, user information on the user, and the like from the input serial number, and sends the acquired information to the help server 30.

(3) Next, the help server 30 narrows down help information to be presented to the user based on the information sent from the apparatus management server 10. After that, the mobile terminal 40 presents the help information.

The overview of flow of processing in the help system (including apparatus management system) according to the embodiment of the present disclosure and the configuration of the help system have been described heretofore.

[Configuration of Apparatus Management Server]

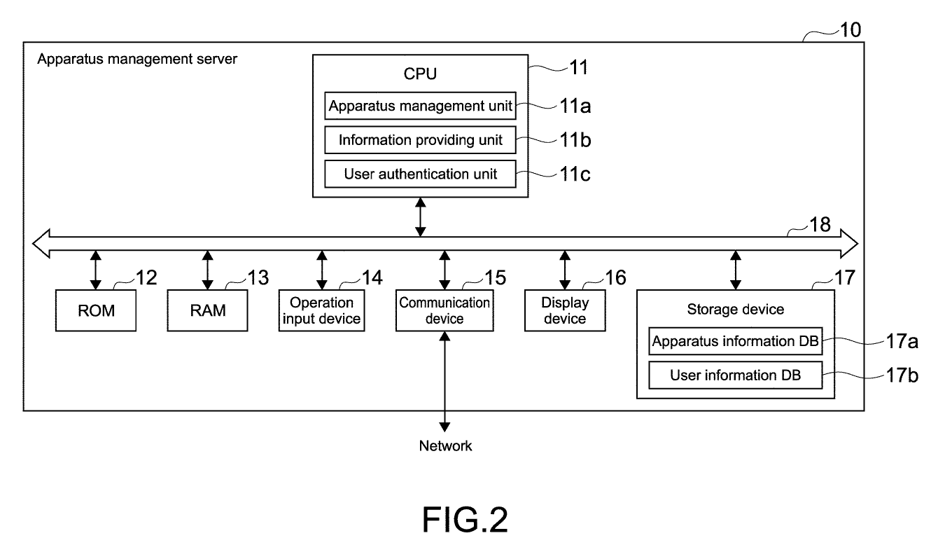

Next, a configuration of the apparatus management server 10 will be described. The apparatus management server 10 may be constituted of dedicated hardware or software, or may be a general-purpose computer. FIG. 2 shows a configuration of the apparatus management server 10 that is a general-purpose computer.

As shown in FIG. 2, the apparatus management server 10 includes a CPU (Central Processing Unit) 11, a ROM (Read Only Memory) 12, a RAM (Random Access Memory) 13, an operation input device 14, a communication device 15 (first communication device), a display device 16, and a storage device 17, and these blocks are connected to each other via a bus 18.

The ROM 12 (second memory) fixedly stores a plurality of programs such as firmware for executing various types of processing, and data. The RAM 13 is used as a work area of the CPU 11 and temporarily stores an OS (Operating System), various applications being executed, and various types of data being processed.

The storage device 17 is, for example, an HDD (Hard Disk Drive), a flash memory, or other nonvolatile memories. The storage device 17 (first memory) stores the apparatus information DB 17a and the user information DB 17b in addition to the OS, various applications, and various types of data.

The communication device 15 is connected to a network for sending/receiving information to/from the image forming apparatus 20, the help server 30, and the mobile terminal 40 of the user.

Of the plurality of programs stored in the ROM 12 or the storage device 17, the CPU 11 loads a program in the RAM 13 in response to a command input via the operation input device 14, and appropriately controls the display device 16 and the storage device 17 according to the loaded program.

The operation input device 14 is, for example, a pointing device such as a mouse, a keyboard, a touch panel, or other operation devices.

The display device 16 is, for example, a liquid crystal display, an EL (Electro-Luminescence) display, or a plasma display.

Next, functional blocks will be described. When the CPU 11 (first processor) of the apparatus management server 10 executes a program (first information processing program), the CPU 11 operates as the functional blocks described below.

The functional blocks that the CPU 11 of the apparatus management server 10 realizes include an apparatus management unit 11a, an information providing unit 11b, and a user authentication unit 11c.

The apparatus management unit 11a collects alert information such as generated errors, configuration information, and the like, from the respective image forming apparatuses 20 under management, and stores the information in the apparatus information DB 17a. Further, the apparatus management unit 11a searches the apparatus information DB 17a and sends apparatus information (a manufacturer name, a model name, a serial number, a type of an attached option, a type of a function, a type of an installed application program, status information, etc.) on the corresponding image forming apparatus 20 and the like to the information providing unit 11b in response to an inquiry using a serial number from a user.

When receiving the apparatus information searched by the apparatus management unit 11a, the information providing unit 11b sends the received apparatus information and the like to the help server 30.

The user authentication unit 11c authenticates a user who logs in with authentication information such as a user name and a password. Note that in the present embodiment, assumption is made that the apparatus management server 10 and the help server 30 perform user authentication using the same authentication information.

The configuration of the apparatus management server 10 has been described heretofore.

[Configuration of Image Forming Apparatus]

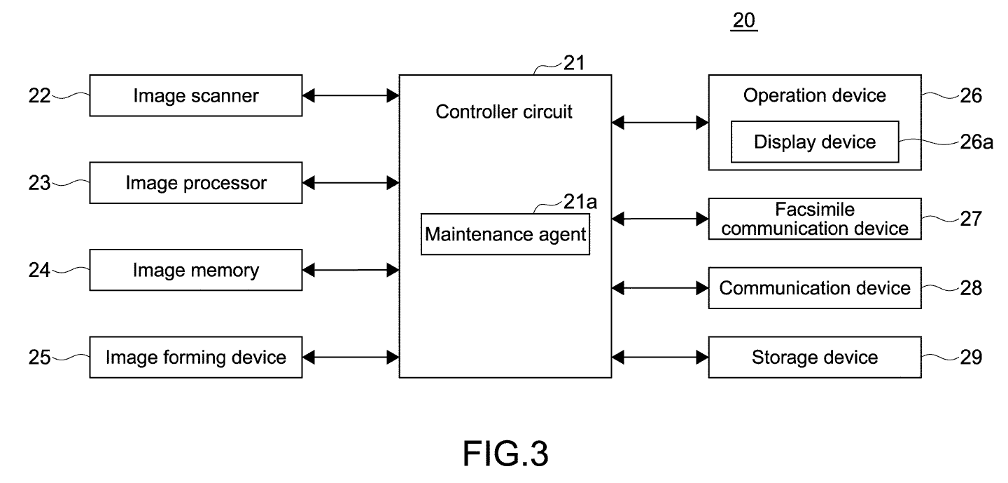

Next, a configuration of the image forming apparatus 20 will be described. FIG. 3 schematically shows the configuration of the image forming apparatus 20.

The image forming apparatus 20 includes a controller circuit 21. The controller circuit 21 includes a CPU, a RAM, a ROM, dedicated hardware circuits, and the like and performs overall operational control of the image forming apparatus 20.

The controller circuit 21 is connected to an image scanner 22, an image processor 23, an image memory 24, an image forming device 25, an operation device 26, a display device 26a, a facsimile communication device 27, a communication device 28 (second communication device), a storage device 29, and the like. The controller circuit 21 performs operational control of the respective devices connected thereto and sends/receives signals and data to/from those devices.

According to job execution instructions input by a user via the operation device 26 or a personal computer (PC) connected to the network, the controller circuit 21 controls drive and processing of mechanisms requisite for executing operational control of functions such as a scanner function, a printing function, a copy function, and a facsimile sending/receiving function.

Further, the controller circuit 21 includes a maintenance agent 21a. The CPU (second processor) of the image forming apparatus 20 loads a program (second information processing program), which is stored in a ROM or the like (third memory), in a RAM and executes the program. When the CPU of the image forming apparatus 20 executes the program, the CPU operates as the maintenance agent 21a, which is a functional block.

The maintenance agent 21a collects configuration information and alert information in the image forming apparatus itself and notifies the apparatus management server 10 of the configuration information and the alert information via the communication device 28.

The image scanner 22 reads an image from a script.

The image processor 23 carries out image processing as necessary on image data of an image read by the image scanner 22. For example, the image processor 23 corrects shading of an image read by the image scanner 22 and carries out other image processing to improve the quality of the image to be formed.

The image memory 24 includes an area that temporarily stores data of a script image read by the image scanner 22 or data to be printed by the image forming device 25.

The image forming device 25 forms an image of image data and the like read by the image scanner 22.

The operation device 26 includes a touch panel device and an operation key device that accept user's instructions on various operations and processing executable by the image forming apparatus 20. The touch panel device includes the display device 26a such as an LCD (Liquid Crystal Display) equipped with a touch panel.

The facsimile communication device 27 includes an encoding/decoding device, a modulation/demodulation device, and an NCU (Network Control Unit) (all of which are not shown) and transmits facsimiles using a public telephone network.

The communication device 28 is constituted of a communication module such as a LAN board and sends/receives various types of data to/from apparatuses such as the apparatus management server 10 via a LAN connected to the communication device 28, and the like.

The storage device 29 stores a script image read by the image scanner 22, and the like. The storage device 29 is a large-volume storage device such as an HDD.

The configuration of the image forming apparatus 20 has been described heretofore.

[Configuration of Help Server]

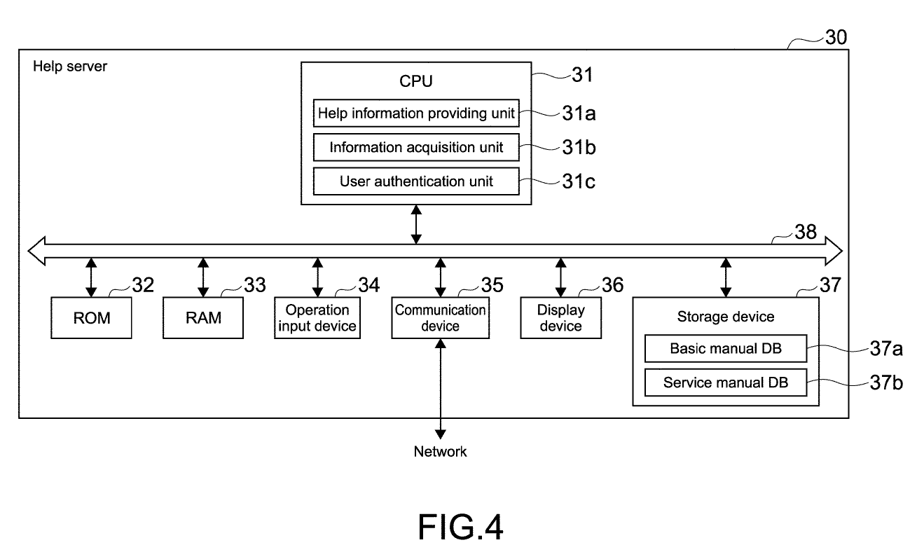

Next, a configuration of the help server 30 will be described. The help server 30 may be constituted of dedicated hardware or software, or may be a general-purpose computer. FIG. 4 shows a configuration of the help server 30 that is a general-purpose computer.

As shown in FIG. 4, the help server 30 includes a CPU 31, a ROM 32, a RAM 33, an operation input device 34, a communication device 35 (third communication device), a display device 36, and a storage device 37, and these blocks are connected to each other via a bus 38.

The ROM 32 fixedly stores a plurality of programs such as firmware for executing various types of processing, and data. The RAM 33 is used as a work area of the CPU 31 and temporarily stores an OS, various applications being executed, and various types of data being processed.

The storage device 37 is, for example, an HDD, a flash memory, or other nonvolatile memories. The storage device 37 (fourth memory) stores the basic manual DB 37a and the service manual DB 37b in addition to the OS, various applications, and various types of data.

The basic manual DB 37a and the service manual DB 37b store categorized help information as described above. Further, the basic manual DB 37a and the service manual DB 37b store also a method of releasing an alert when the alert occurs in the image forming apparatus 20.

The communication device 35 is connected to a network for sending/receiving information to/from the apparatus management server 10 and the mobile terminal 40 of the user.

Of the plurality of programs stored in the ROM 32 (fourth memory) or the storage device 37 (fifth memory), the CPU 31 loads a program in the RAM 33 in response to a command input via the operation input device 34, and appropriately controls the display device 36 and the storage device 37 according to the loaded program.

The operation input device 34 is, for example, a pointing device such as a mouse, a keyboard, a touch panel, or other operation devices.

The display device 36 is, for example, a liquid crystal display, an EL display, or a plasma display.

Next, functional blocks will be described. When the CPU 31 (third processor) of the help server 30 executes a program (third information processing program), the CPU 31 operates as the functional blocks described below.

The functional blocks that the CPU 31 of the help server 30 realizes include a help information providing unit 31a, an information acquisition unit 31b, and a user authentication unit 31c.

The help information providing unit 31a narrows down help information stored in the basic manual DB 37a and the service manual DB 37b based on the apparatus information and the user information sent from the information acquisition unit 31b, and provides the help information to the user.

The information acquisition unit 31b sends the apparatus information and the user information received from the apparatus management server 10 to the help information providing unit 31a.

The user authentication unit 31c authenticates a user who logs in to the help server 30.

The configuration of the help server 30 has been described heretofore.

[Configuration of Mobile Terminal]

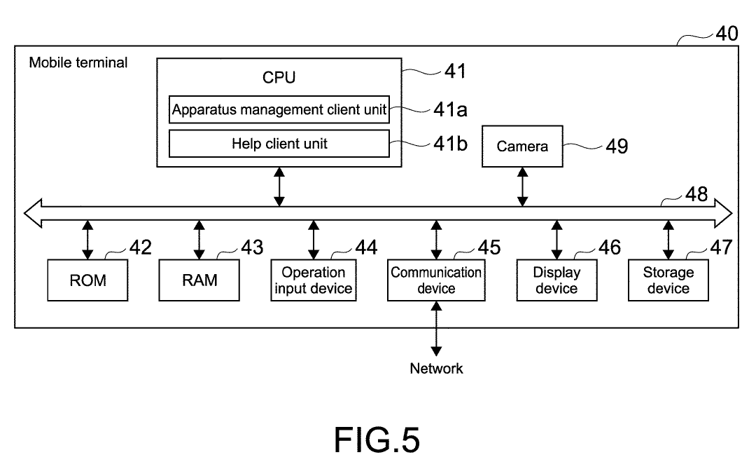

Next, a configuration of the mobile terminal 40 will be described. The mobile terminal 40 may be constituted of dedicated hardware or software, or may be a general-purpose computer. FIG. 5 shows a configuration of the mobile terminal 40 that is a general-purpose computer.

As shown in FIG. 5, the mobile terminal 40 includes a CPU 41, a ROM 42, a RAM 43, an operation input device 44, a communication device 45 (fourth communication device), a display device 46, a storage device 47, and a camera 49, and these blocks are connected to each other via a bus 48.

The ROM 42 (sixth memory) fixedly stores a plurality of programs such as firmware for executing various types of processing, and data. The RAM 43 is used as a work area of the CPU 41 and temporarily stores an OS, various applications being executed, and various types of data being processed.

The storage device 47 is, for example, an HDD, a flash memory, or other nonvolatile memories. The storage device 47 stores the OS, various applications, and various types of data.

The communication device 45 is connected to a network for sending/receiving information to/from the apparatus management server 10 and the help server 30.

Of the plurality of programs stored in the ROM 42 (fourth memory) or the storage device 47, the CPU 41 loads a program in the RAM 43 in response to a command input via the operation input device 44, and appropriately controls the display device 46 and the storage device 47 according to the loaded program.

The operation input device 44 is, for example, a touch panel, or other operation devices.

The display device 46 is, for example, a liquid crystal display, or an EL display.

The camera 49 is used to take an image of a product information registration tag (e.g., QR code (registered trademark)) attached to the image forming apparatus 20.

Next, functional blocks will be described. When the CPU 41 (fourth processor) of the mobile terminal 40 executes a program (fourth information processing program), the CPU 41 operates as the functional blocks described below.

The functional blocks that the CPU 41 of the mobile terminal 40 realizes include an apparatus management client unit 41a and a help client unit 41b.

The apparatus management client unit 41a provides a user interface for the mobile terminal 40 to access the apparatus management server 10 and input the serial number of the image forming apparatus 20 on which help information is desired to be displayed.

The help client unit 41b provides a user interface for the mobile terminal 40 to access the help server 30 and obtain help information.

The configuration of the mobile terminal 40 has been described heretofore.

[Screen Example (Part 1)]

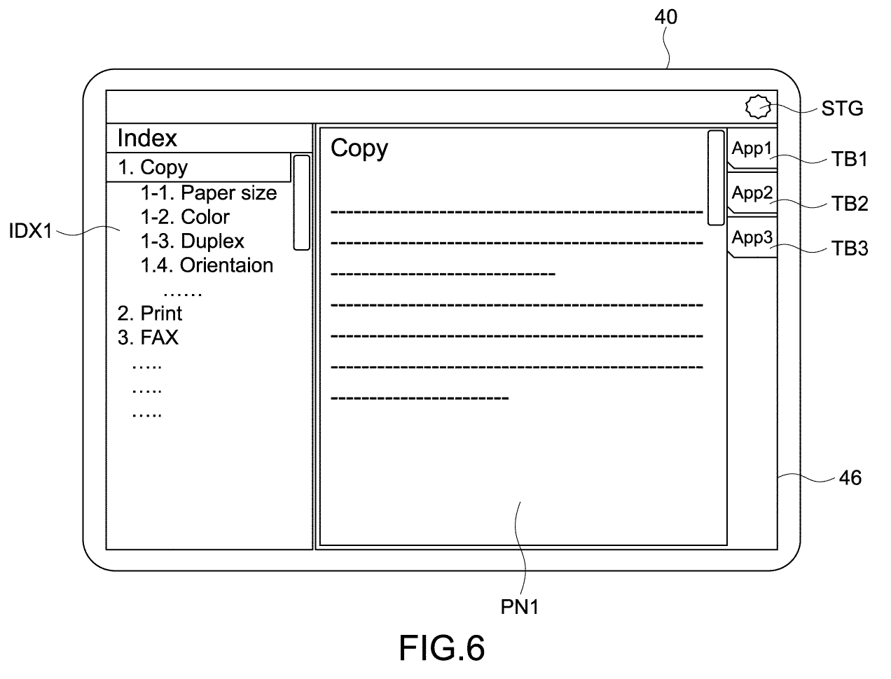

Next, a display example (part 1) of help information displayed by the mobile terminal 40 will be described. FIG. 6 illustrates a display example (part 1) of help information displayed by the mobile terminal 40.

In the example shown in FIG. 6, a table of contents (or index) of help on the function of the target image forming apparatus 20 is displayed on an item IDX1 on the left part of a screen 46 of the mobile terminal 40, and the content of the help information is displayed in a right pane PN1.

In the present example, it can be seen that the target image forming apparatus 20 has a copy function, a printing function, and a FAX function.

Note that the present example is an example of a case where the user is a general user, and help information disclosed only to a service person is not presented.

On the upper right of the screen, a button STG for changing settings of languages and the like and tabs TB1 to TB3 for calling help information corresponding to application programs installed in the image forming apparatus 20 are displayed.

Note that the language for displaying the help is displayed based on the language used by the logged-in user unless explicitly changed by the button STG.

Note that the number of tabs TB1 to TB3 is changed depending on the content of the apparatus information sent from the apparatus management server 10 to the help server 30, i.e., how many application programs are installed in the image forming apparatus 20 on which help information is desired to be referred to.

The display example (part 1) of help information displayed by the mobile terminal 40 has been described heretofore.

[Screen Example (Part 2)]

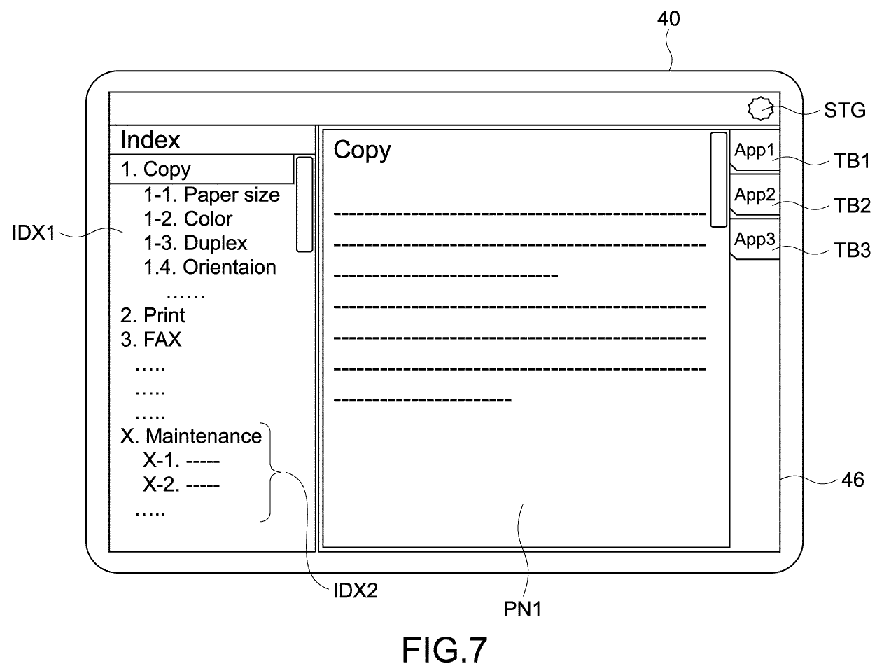

Next, a display example (part 2) of help information displayed by the mobile terminal 40 will be described. FIG. 7 illustrates a display example (part 2) of help information displayed by the mobile terminal 40.

The example shown in FIG. 7 is an example of a case where a user whose account role is a service person refers to help information using the mobile terminal 40.

Therefore, in addition to the item IDX1 of the basic help information, an item IDX2 of help information that the service person refers to when maintaining the image forming apparatus 20 is added to the portion on the left side of the screen.

The display example (part 2) of help information displayed by the mobile terminal 40 has been described heretofore.

[Screen Example (Part 3)]

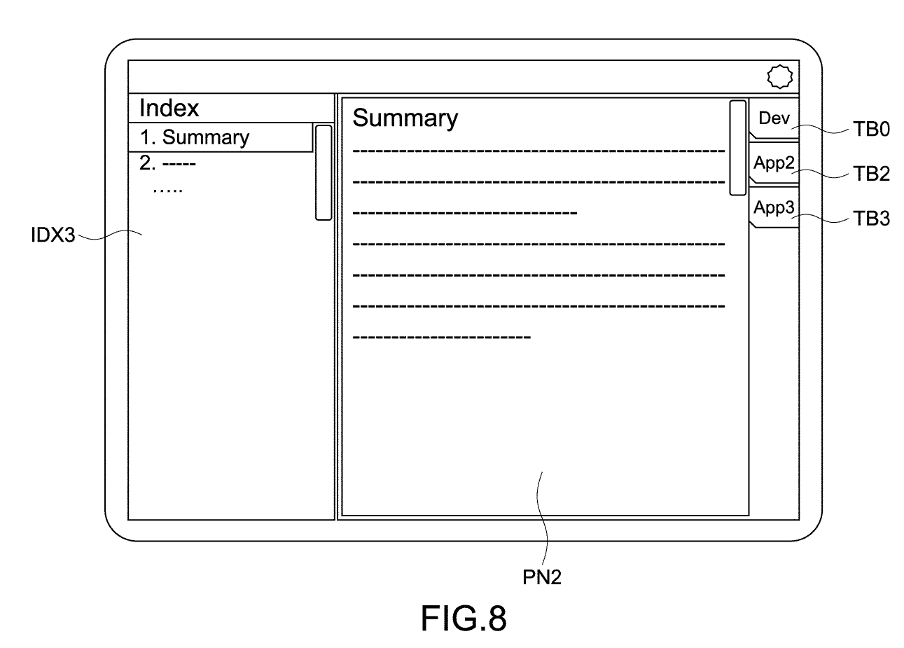

Next, a display example (part 3) of help information displayed by the mobile terminal 40 will be described. FIG. 8 illustrates a display example (part 3) of help information displayed by the mobile terminal 40.

In the example shown in FIG. 8, the mobile terminal 40 displays the help information of an application program (Appl) installed in the image forming apparatus 20 on which the user refers to the help information.

The screen is displayed by selecting the tab TB1 on the right side of the screen from the screen shown in FIG. 6 or FIG. 7. At this time, the help information of the apparatus itself, which has been displayed, is displayed in a state that can be referred to by a tab TB0 displayed as “Dev”.

The display example (part 3) of help information displayed by the mobile terminal 40 has been described heretofore.

[Detailed Flow of Processing (Part 1)]

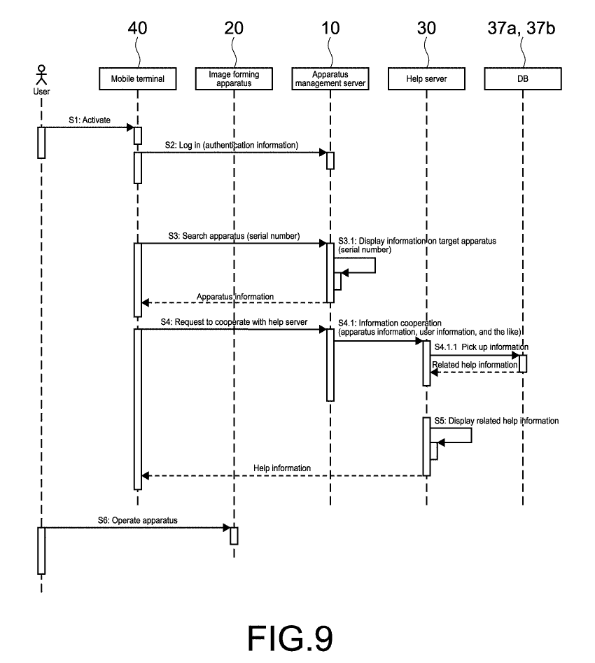

Next, detailed flow of processing (part 1) in the help system 1 will be described. FIG. 9 is a sequence diagram for describing the detailed flow of processing (part 1) in the help system 1.

First, a user activates the mobile terminal 40 (Step S1).

Next, the apparatus management client unit 41a logs in to the apparatus management server 10 by using authentication information based on a user's instruction (Step S2). The user authentication unit 11c of the apparatus management server 10 performs user authentication.

Next, the apparatus management client unit 41a accepts the serial number of the image forming apparatus 20 on which help information is desired to be displayed based on the input from the user, and sends a search request to the apparatus management server 10 by using the accepted serial number (Step S3).

Next, the apparatus management unit 11a of the apparatus management server 10 receives the search request from the mobile terminal 40, and searches for apparatus information and the like from the apparatus information DB 17a by using the attached serial number (Step S3.1). The apparatus management unit 11a returns the searched apparatus information and the like to the mobile terminal 40.

Next, the apparatus management client unit 41a requests the apparatus management server 10 to cooperate with the help server 30 (Step S4).

Next, the apparatus management unit 11a of the apparatus management server 10 sends the searched apparatus information and the like to the information providing unit 11b in response to the cooperation request from the mobile terminal 40. The information providing unit 11b logs in to the help server 30 by using the authentication information used when the user logs in to the apparatus management server 10, and sends the received apparatus information and the like to the help server 30 (Step S4.1).

Next, the information acquisition unit 31b of the help server 30 receives the apparatus information sent from the apparatus management server 10, and the received apparatus information to the help information providing unit 31a. The help information providing unit 31a searches the basic manual DB 37a and the service manual DB 37b by using the received apparatus information and the like, and extracts help information relating to the target image forming apparatus 20 (Step S4.1.1).

Next, the help information providing unit 31a of the help server 30 sends the help information extracted by the help client unit 41b of the mobile terminal 40. The mobile terminal 40 displays the help information on a display device 46 (Step S5).

Next, the user refers to the help information displayed on the display device 46 of the mobile terminal 40, and operates the image forming apparatus 20 (Step S6).

The detailed flow of processing (part 1) in the help system 1 has been described heretofore.

[Schematic Flow of Processing (Part 2)]

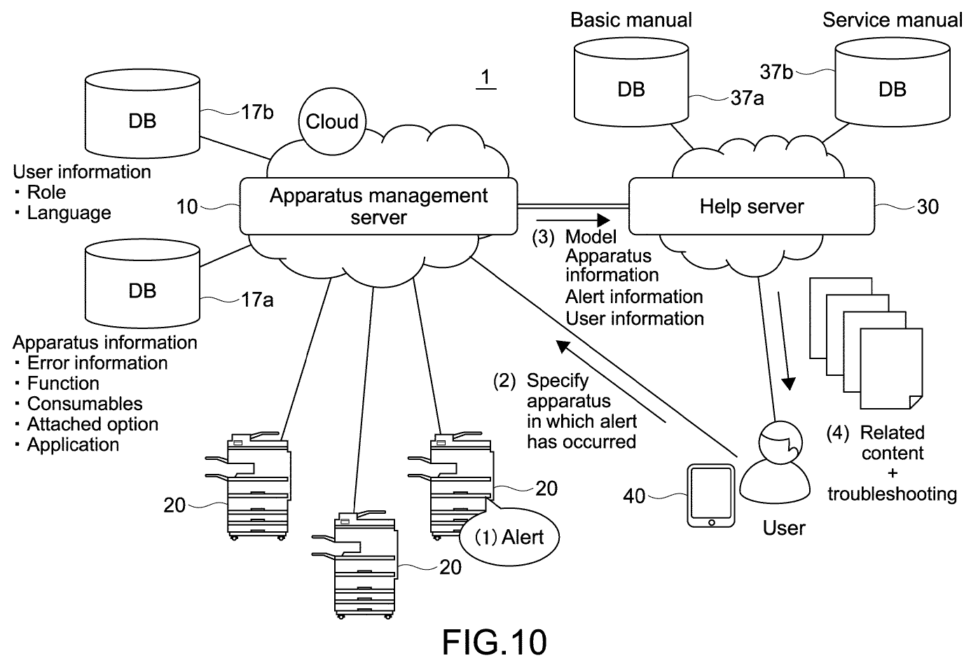

Next, schematic flow (part 2) of processing in the help system 1 according to the embodiment of the present disclosure will be described. FIG. 10 schematically illustrates flow (part 2) of processing in the help system 1 according to the embodiment of the present disclosure.

(1) First, assumption is made that an alert has occurred in any of the image forming apparatuses 20 managed by the apparatus management server 10.

(2) Next, the mobile terminal 40 of the user logs in to the apparatus management server 10, and specifies the image forming apparatus 20 in which the alert has occurred.

(3) Next, the apparatus management server 10 sends alert information, apparatus information, and the like to the help server 30.

(4) Next, the help server 30 sends, to the mobile terminal 40, help information relating to the image forming apparatus 20 in which the alert has occurred and a method (troubleshooting) for solving the cause of the alert that has occurred. The mobile terminal 40 presents the help information and the method for solving the cause of the alert to the user.

The schematic flow (part 2) of processing in the help system 1 according to the embodiment of the present disclosure has been described heretofore.

[Screen Example (Part 4)]

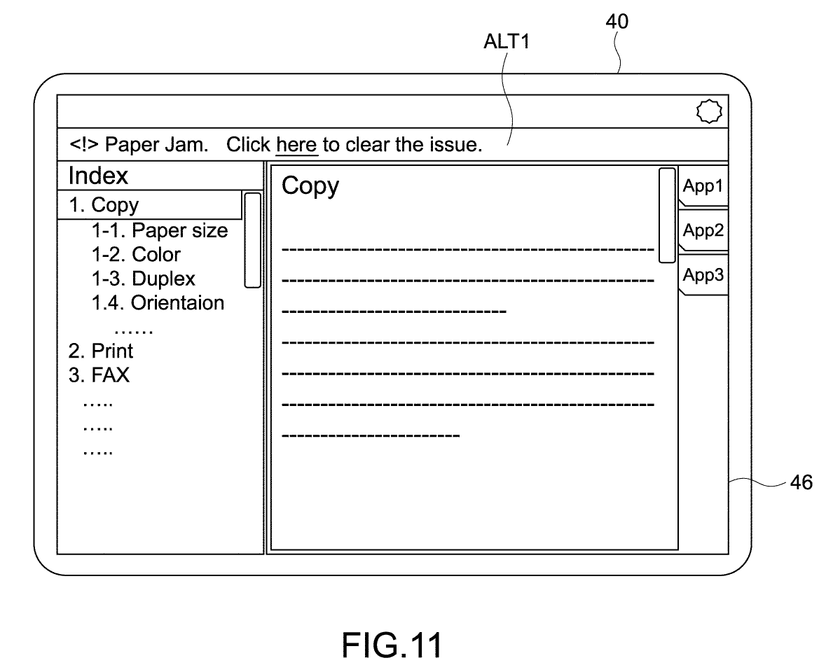

Next, a display example (part 4) of help information displayed by the mobile terminal 40 will be described. FIG. 11 illustrates a display example (part 4) of help information displayed by the mobile terminal 40.

In the example shown in FIG. 11, an alert message ALT1 moves like subtitles at the top of normal help information.

When the user clicks (taps) the designated part in the alert message ALT1, a method for solving the cause of the currently occurring alert is displayed.

The display example (part 4) of help information displayed by the mobile terminal 40 has been described heretofore.

[Screen Example (Part 5)]

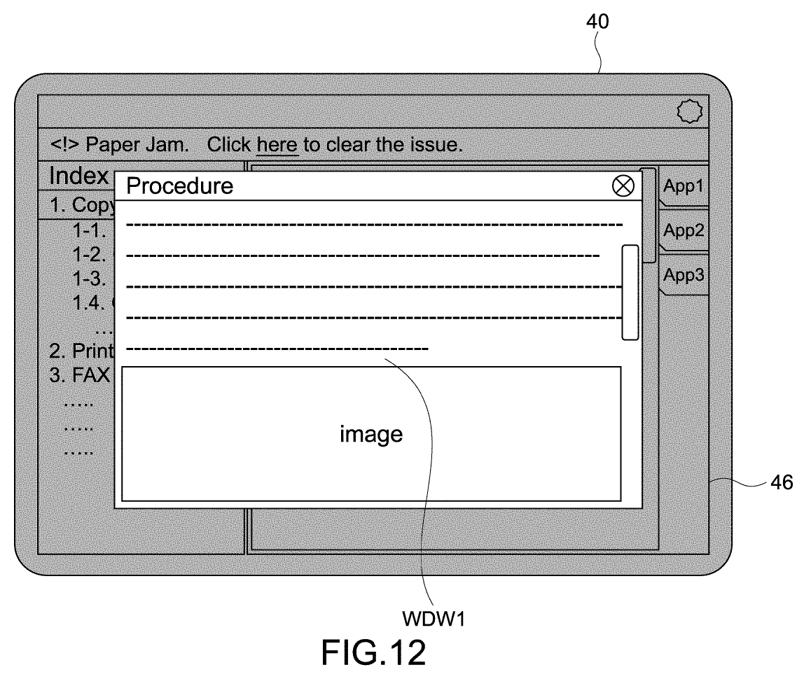

Next, a display example (part 5) of help information displayed by the mobile terminal 40 will be described. FIG. 12 illustrates a display example (part 5) of help information displayed by the mobile terminal 40.

In the example shown in FIG. 12, the user clicks the specified part in the alert message ALT1, and a window WDW1 indicating a method for solving the cause of the currently occurring alert is displayed on the screen.

The display example (part 5) of help information displayed by the mobile terminal 40 has been described heretofore.

[Detailed Flow of Processing (Part 2)]

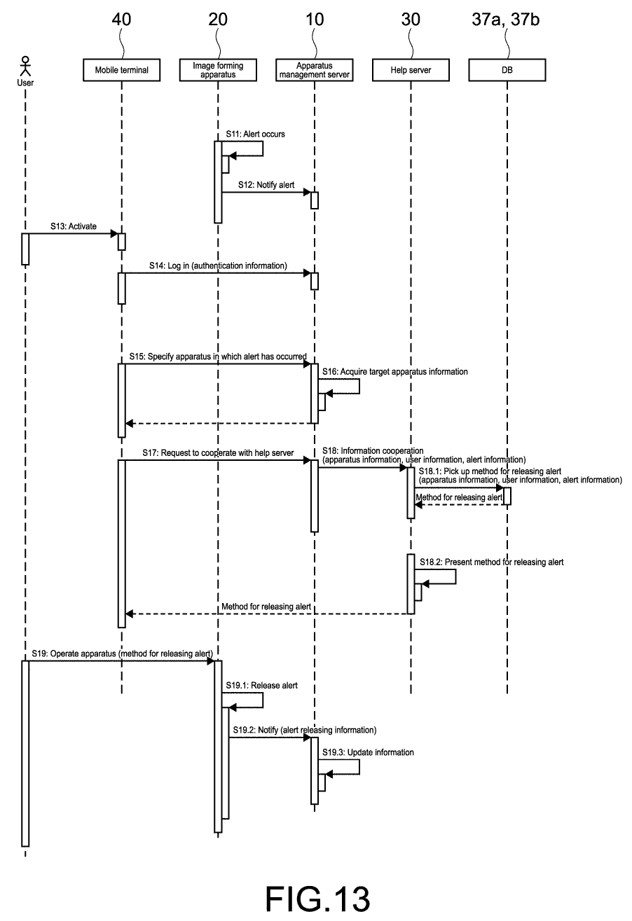

Next, detailed flow of processing (part 2) in the help system 1 will be described. FIG. 13 is a sequence diagram for describing the detailed flow of processing (part 2) in the help system 1.

First, assumption is made that an alert has occurred in one of the image forming apparatuses 20 under management of the apparatus management server 10 (Step S11).

Next, the maintenance agent 21a of the image forming apparatus 20 in which the alert has occurred notifies the apparatus management server 10 of alert information (Step S12).

Next, the user activates the mobile terminal 40 (Step S13).

Next, the apparatus management client unit 41a logs in to the apparatus management server 10 by using authentication information based on a user's instruction (Step S14). When the apparatus management client unit 41a logs in to the apparatus management server 10, the image forming apparatus 20 in which the alert has occurred is displayed.

Next, the apparatus management client unit 41a specifies the image forming apparatus 20 in which the alert has occurred based on a user's input (Step S15).

Next, the apparatus management unit 11a of the apparatus management server 10 acquires, from the apparatus information DB 17a, apparatus information and the like relating to the specified image forming apparatus 20 (Step S16). The apparatus management unit 11a returns the acquired apparatus information and the like to the mobile terminal 40.

Next, the apparatus management client unit 41a requests the apparatus management server 10 to cooperate with the help server 30 (Step S17).

Next, the apparatus management unit 11a of the apparatus management server 10 sends the acquired apparatus information and the like to the information providing unit 11b based on the cooperation request from the mobile terminal 40. The information providing unit 11b logs in to the help server 30 by using the authentication information used when the user logs in to the apparatus management server 10, and sends the received apparatus information and the like (including alert information) to the help server 30 (Step S18).

Next, the information acquisition unit 31b of the help server 30 receives apparatus information and the like sent from the apparatus management server 10, and sends the received apparatus information and the like to the help information providing unit 31a. The help information providing unit 31a searches the basic manual DB 37a and the service manual DB 37b by using the received apparatus information and the like, and extracts help information (including the method for solving the cause of the alert) relating to the target image forming apparatus 20 (Step S18.1).

Next, the help information providing unit 31a of the help server 30 sends the extracted help information to the help client unit 41b of the mobile terminal 40. The mobile terminal 40 displays the help information on the display device 46 (Step S18.2).

Next, the user refers to the help information displayed on the display device 46 of the mobile terminal 40, and operates the image forming apparatus 20 to solve the cause of the alert (Step S19).

Next, the maintenance agent 21a releases the alert (step S19.1).

Next, the maintenance agent 21a notifies the apparatus management server 10 that the alert has been released (Step S19.2).

Next, the apparatus management unit 11a of the apparatus management server 10 updates the apparatus information DB 17a (Step S19.3).

The detailed flow of processing (part 2) in the help system 1 has been described heretofore.

[Schematic Flow of Processing (Part 3)]

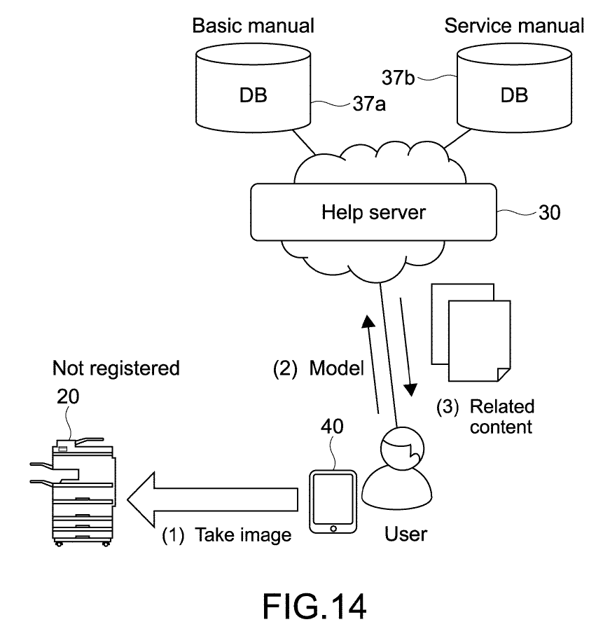

Next, schematic flow of processing (part 3) in the help system 1 according to the embodiment of the present disclosure will be described. FIG. 14 schematically illustrates flow of processing (part 3) in the help system 1 according to the embodiment of the present disclosure.

Note the flow of processing (part 3) is processing executed by the mobile terminal 40 when directly acquiring, from the help server 30, help information relating to the image forming apparatus 20 not under management of the apparatus management server 10.

(1) First, the camera 49 of the mobile terminal 40 take an image of a product information registration tag (e.g., QR code (registered trademark)) attached to the image forming apparatus 20.

Note that in the product information registration tag, simple information such as information on the manufacturer name, model name, and serial number of the image forming apparatus 20 is registered.

(2) Next, the help client unit 41b sends the manufacture name, model name, and the like to the help server 30.

(3) The help server 30 returns help information relating to the sent manufacture name, model name, and the like to the mobile terminal 40.

Note that in the case of displaying help information relating to the image forming apparatus 20 not under management of the apparatus management server 10, since information (manufacturer name, model name, etc.) for narrowing down the help information is limited, it cannot be narrowed down as in the case where the help information is narrowed down in cooperation with the apparatus management server 10 as described above.

The schematic flow of processing (part 3) in the help system 1 according to the embodiment of the present disclosure has been described heretofore.

[Supplementary Note]

As described above, the help system 1 according to the present disclosure includes an apparatus management server 10; one or more image forming apparatuses 20; a help server 30; and a mobile terminal 40, in which the apparatus management server 10 includes a first communication device 15 capable of performing network communication, a first memory that stores an apparatus information database, apparatus information relating to the one or more image forming apparatuses 20 being stored in the apparatus information database, a second memory that stores a first information processing program, and a first processor that executes the first information processing program, when the first processor executes the first information processing program, the first processor collects the apparatus information from the one or more image forming apparatuses 20 and manages the collected apparatus information in the apparatus information database, and sends the apparatus information to the help server 30, the one or more image forming apparatuses 20 each include a second communication device 28 capable of performing network communication, a third memory that stores a second information processing program, and a second processor that executes the second information processing program, when the second processor executes the second information processing program, the second processor sends the apparatus information relating to the image forming apparatus 20 itself to the apparatus management server 10, the help server 30 includes a third communication device 35 capable of performing network communication, a fourth memory that stores a manual database, help information to be presented to a user being categorized and stored in the manual database, a fifth memory that stores a third information processing program, and a third processor that executes the third information processing program, when the third processor executes the third information processing program, the third processor extracts help information relating to the sent apparatus information among the help information stored in the manual database and sends the extracted help information to the mobile terminal, and receives the apparatus information sent from the apparatus management server 10, the mobile terminal 40 includes a fourth communication device 45 capable of performing network communication, a sixth memory that stores a forth information processing program, and a forth processor that executes the forth information processing program, and when the forth processor executes the forth information processing program, the forth processor operates as a user interface for sending/receiving information to/from the apparatus management server, and operates as a user interface for sending/receiving information to/from the help server, and in which the forth processor of the mobile terminal acquires a serial number of the image forming apparatus of which the user wants to know help information among the one or more image forming apparatuses, the forth processor of the mobile terminal 40 sends the serial number to the apparatus management server 10, the first processor of the apparatus management server 10 searches the apparatus information database based on the received serial number and extracts the corresponding apparatus information, the first processor of the apparatus management server 10 sends the extracted apparatus information to the help server 30, the third processor of the help server 30 receives the apparatus information sent from the apparatus management server 10, the third processor of the help server 30 extracts help information relating to the sent apparatus information among the help information stored in the manual database and sends the extracted apparatus information to the mobile terminal 40, and the forth processor of the mobile terminal 40 presents the received help information to the user.

With this configuration, it is possible to minimize the user's trouble of referring to help in cooperation with the apparatus management system.

It should be understood by those skilled in the art that various modifications, combinations, sub-combinations and alterations may occur depending on design requirements and other factors insofar as they are within the scope of the appended claims or the equivalents thereof.

What is claimed is:

1. A help system, comprising:
an apparatus management server;
one or more image forming apparatuses;
a help server; and
a mobile terminal, wherein
the apparatus management server includes
a first communication device capable of performing network communication,
a first memory that stores an apparatus information database,
apparatus information relating to the one or more image forming apparatuses being stored in the apparatus information database,
a second memory that stores a first information processing program, and
a first processor that executes the first information processing program,
when the first processor executes the first information processing program, the first processor
collects the apparatus information from the one or more image forming apparatuses and manages the collected apparatus information in the apparatus information database, and
sends the apparatus information to the help server,
the one or more image forming apparatuses each include
a second communication device capable of performing network communication,
a third memory that stores a second information processing program, and
a second processor that executes the second information processing program,
when the second processor executes the second information processing program, the second processor
sends the apparatus information relating to the image forming apparatus itself to the apparatus management server,
the help server includes
a third communication device capable of performing network communication,
a fourth memory that stores a manual database, help information to be presented to a user being categorized and stored in the manual database,
a fifth memory that stores a third information processing program, and
a third processor that executes the third information processing program,
when the third processor executes the third information processing program, the third processor
extracts help information relating to the sent apparatus information among the help information stored in the manual database and sends the extracted help information to the mobile terminal, and
receives the apparatus information sent from the apparatus management server,
the mobile terminal includes
a fourth communication device capable of performing network communication,
a sixth memory that stores a forth information processing program, and
a forth processor that executes the forth information processing program, and
when the forth processor executes the forth information processing program, the forth processor
operates as a user interface for sending/receiving information to/from the apparatus management server, and
operates as a user interface for sending/receiving information to/from the help server, and
wherein
the forth processor of the mobile terminal acquires a serial number of the image forming apparatus of which the user wants to know help information among the one or more image forming apparatuses,
the forth processor of the mobile terminal sends the serial number to the apparatus management server,
the first processor of the apparatus management server searches the apparatus information database based on the received serial number and extracts the corresponding apparatus information,
the first processor of the apparatus management server sends the extracted apparatus information to the help server,
the third processor of the help server receives the apparatus information sent from the apparatus management server,
the third processor of the help server extracts help information relating to the sent apparatus information among the help information stored in the manual database and sends the extracted apparatus information to the mobile terminal, and
the forth processor of the mobile terminal presents the received help information to the user.

2. The help system according to claim 1, wherein
the apparatus information includes information on a manufacturer name, a model name, a serial number, a type of an attached option, a type of a function, a type of an installed application program, and status information.

3. The help system according to claim 1, wherein
when an alert occurs in any of the one or more image forming apparatuses,
the second processor of the image forming apparatus in which the alert has occurred notifies the apparatus management server of alert information relating to the alert that has occurred,
when the forth processor of the mobile terminal accesses the apparatus management server, the first processor of the apparatus management server presents the image forming apparatus in which the alert has occurred to the user,
the forth processor of the mobile terminal specifies the image forming apparatus in which the alert has occurred based on a user's input,
the first processor of the apparatus management server extracts the apparatus information corresponding to the specified image forming apparatus from the apparatus information database,
the first processor of the apparatus management server sends the extracted apparatus information and the alert information to the help server,
the third processor of the help server receives the apparatus information and the alert information sent from the apparatus management server,
the third processor of the help server extracts help information relating to the received apparatus information and the received alert information among the help information stored in the manual database and sends the extracted help information, and
the forth processor of the mobile terminal presents the received help information to the user.

4. A help presentation method for a help system including an apparatus management server, one or more image forming apparatuses, a help server, and a mobile terminal connected to each other, the help presentation method comprising:
acquiring, by the mobile terminal, a serial number of the image forming apparatus of which a user wants to know help information among the one or more image forming apparatuses,
sending, by the mobile terminal, the serial number to the apparatus management server,
searching, by the apparatus management server, an apparatus information database based on the received serial number and extracts the corresponding apparatus information, apparatus information relating to the one or more image forming apparatuses being stored in the apparatus information database,
sending, by the apparatus management server, the extracted apparatus information to the help server,
receiving, by the help server, the apparatus information sent from the apparatus management server,
extracting, by the help server, help information relating to the sent apparatus information among the help information stored in a manual database and sending the extracted apparatus information to the mobile terminal, the help information to be presented to the user being categorized and stored in the manual database, and
presenting, by the mobile terminal, the received help information to the user.

5. The help presentation method according to claim 4, further comprising:
when an alert occurs in any of the one or more image forming apparatuses,
notifying, by the image forming apparatus in which the alert has occurred, the apparatus management server of alert information relating to the alert that has occurred,
when the forth processor of the mobile terminal accesses the apparatus management server,
presenting, by the apparatus management server, the image forming apparatus in which the alert has occurred to the user,
specifying, by the mobile terminal, the image forming apparatus in which the alert has occurred based on a user's input,
extracting, by the apparatus management server, the apparatus information corresponding to the specified image forming apparatus from the apparatus information database,
sending, by the apparatus management server, the extracted apparatus information and the alert information to the help server,
receiving, by the help server, the apparatus information and the alert information sent from the apparatus management server,
extracting, by the help server, help information relating to the received apparatus information and the received alert information among the help information stored in the manual database and sends the extracted help information, and
presenting, by the mobile terminal, the received help information to the user.
